(19) United States
(12) Patent Application Publication
(10) Pub. No.: US 2022/0292064 A1
(43) Pub. Date: Sep. 15, 2022

(54) SYSTEMS AND METHODS FOR GENERATING DATABASE ASSETS

(71) Applicant: Embarcadero Technologies, Inc., Austin, TX (US)

(72) Inventors: Jamie Knowles, Welford (GB); Jason Hahn, Pacific Grove, CA (US)

(21) Appl. No.: 17/683,062

(22) Filed: Feb. 28, 2022

Related U.S. Application Data
(60) Provisional application No. 63/161,349, filed on Mar. 15, 2021.

(51) Int. Cl. G06F 16/21; G06F 16/242; G06F 16/22

(52) U.S. Cl. CPC G06F 16/213; G06F 16/2435; G06F 16/2282

(57) ABSTRACT

A method for generating a database uses a first data structure including elements, where the method includes generating a second data structure using the first data structure. The second data structure corresponds to a Logical Data Model, and is mapped to the elements of the first data structure. The method further includes generating a third data structure using the second data structure, where the third data structure corresponds to a Physical Data Model. The method further includes generating the database using the third data structure.

### CROSS-REFERENCE TO RELATED APPLICATIONS AND CLAIM OF PRIORITY

This application claims the benefit of U.S. Provisional Application No. 63/161,349, filed Mar. 15, 2021, the content of which are fully incorporated herein by reference in its entirety.

### BACKGROUND

An organization (e.g., a company) generates, uses, stores, and updates various types of data or information in the course of operation. Examples of such information include but are not limited to, vendor information, client information, competitor information, and so on. Typically, the meaning or understanding of the information of an organization is based on Business Terms in a Business Glossary. On the other hand, data architects typically document and design data assets of a database using Logical Data Models, where the Business Glossary and the Logical Data Models are different data models/structures, and are generated/maintained separately. In that regard, conventionally, Business Glossary and Logical Data Models can be manually connected via manual entry in order to maintain traceability for data governance. In other words, an operator can manually enter correspondence between data assets in each Business Term with one or more elements of the Logical Data Models. Further, requirements for data assets presented in Business Terms can be manually recreated and then manually mapped back to those Business Terms. However, such manual conversion and mapping operations are not only time-consuming but also prone to human errors.

The above information disclosed in this Background section is for enhancement of understanding of the background of the disclosure, and therefore, it can contain information that does not constitute prior art.

### SUMMARY

Example embodiments of the present disclosure relate to a method for generating a database using a first data structure comprising elements, where the method includes generating a second data structure using the first data structure. The second data structure corresponds to a Logical Data Model, and is mapped to the elements of the first data structure. The method further includes generating a third data structure using the second data structure, where the third data structure corresponds to a Physical Data Model. The method further includes generating the database using the third data structure.

In further examples, the first data structure conforms to a Business Glossary metamodel, and each of the elements comprises a Business Term.

In further examples, the Physical Data Model is one of a relational model or a dimensional model, and generating the database using the third data structure includes generating a database code using the third data structure.

In further examples, the database code includes Dynamical Definition Language (DDL) code expressed in Standard Query Language (SQL).

In further examples, the database code includes JSON.

In further examples, the third data structure is generated using the second data structure based on one or more of data type conversions, primary key constraints, foreign key constraints, or naming conventions.

In further examples, generating the second data structure using the first data structure includes identifying one or more relationships of each of the elements, identifying one or more elements of the elements that do not have an “is attribute of” relationship with another element of the elements, creating an Entity of the second data structure corresponding to each of the one or more elements, and mapping the Entity to each of the one or more elements.

In further examples, generating the second data structure using the first data structure further includes identifying one or more relationships of each of the one or more elements, and creating one or more of Attributes, Relationships, or SubType cluster of the second data structure based on the one or more relationships.

Further example embodiments relate to a non-transitory computer-readable medium having computer-readable instructions such that, when executed by at least one processor, causes the processor to generate a database using a first data structure comprising elements by generating a second data structure using the first data structure, wherein the second data structure corresponds to a Logical Data Model, the second data structure mapped to the elements of the first data structure. The computer-readable instructions, when executed by at least one processor, further causes the processor to generate a third data structure using the second data structure, the third data structure corresponds to a Physical Data Model, and to generate the database using the third data structure.

In further examples of the non-transitory computer-readable medium, the first data structure corresponds to a Business Glossary metamodel, and each of the elements comprises a Business Term.

In further examples of the non-transitory computer-readable medium, the Physical Data Model is one of a relational model or a dimensional model, and generating the database using the third data structure comprises generating a database code using the third data structure.

In further examples of the non-transitory computer-readable medium, the database code comprises Dynamical Definition Language (DDL) code expressed in Standard Query Language (SQL).

In further examples of the non-transitory computer-readable medium, the database code comprises JSON.

In further examples of the non-transitory computer-readable medium, the third data structure is generated using the second data structure based on one or more of data type conversions, primary key constraints, foreign key constraints, or naming conventions.

In further examples of the non-transitory computer-readable medium, generating the second data structure using the first data structure includes identifying one or more relationships of each of the elements, identifying one or more elements of the elements that do not have an “is attribute of” relationship with another element of the elements, creating an Entity of the second data structure corresponding to each of the one or more elements, and mapping the Entity to each of the one or more elements.

In further examples of the non-transitory computer-readable medium, generating the second data structure using the first data structure further includes identifying one or more relationships of each of the one or more elements, and creating one or more of Attributes, Relationships, or SubType cluster of the second data structure based on the one or more relationships.

Further example embodiments relate to a system for generating a database using a first data structure comprising elements. The system includes a memory and a processor configured to generate a second data structure using the first data structure, wherein the second data structure corresponds to a Logical Data Model, the second data structure mapped to the elements of the first data structure, generate a third data structure using the second data structure, the third data structure corresponds to a Physical Data Model, and generate the database using the third data structure.

In further examples of the system, the first data structure conforms to a Business Glossary metamodel, and each of the elements comprises a Business Term.

In further examples of the system, generating the second data structure using the first data structure includes identifying one or more relationships of each of the elements, identifying one or more elements of the elements that do not have an “is attribute of” relationship with another element of the elements, creating an Entity of the second data structure corresponding to each of the one or more elements, and mapping the Entity to each of the one or more elements.

In further examples of the system, generating the second data structure using the first data structure further includes identifying one or more relationships of each of the one or more elements, and creating one or more of Attributes, Relationships, or SubType cluster of the second data structure based on the one or more relationships.

### BRIEF DESCRIPTION OF THE DRAWINGS

FIG. 1 is a block diagram depicting a computing device, according to some arrangements.

FIG. 2 is a diagram illustrating an example Business Glossary metamodel, according to some arrangements.

FIG. 3 is a diagram illustrating an example Logical Data Model, according to some arrangements.

FIG. 4 is a flow diagram illustrating an example method for generating a database, according to some arrangements.

FIG. 5 is a flow diagram illustrating an example method for generating a second data structure using the first data structure, according to some arrangements.

FIG. 6 is a flow diagram illustrating an example method for generating a second data structure using the first data structure, according to some arrangements.

FIG. 7 is a diagram illustrating an example Business Glossary metamodel, according to some arrangements.

FIG. 8 is a diagram illustrating an example Logical Data Model, according to some arrangements.

### DETAILED DESCRIPTION

Hereinafter, example implementations will be described in more detail with reference to the accompanying drawings, in which like reference numbers refer to like elements throughout. The present disclosure, however, can be embodied in various different forms, and should not be construed as being limited to only the illustrated examples herein. Rather, these examples are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure cannot be described. Unless otherwise noted, like reference numerals denote like elements throughout the attached drawings and the written description.

Arrangements disclosed herein relate to automatically converting and mapping Business Terms (with relationships) to a Logical Data Model. Mapping Business Terms to fields in databases can allow a user to efficiently and accurately find data in the databases and to understand rules associated with those fields, where such rules are defined against the Business Terms.

As used herein, Data Governance refers to the discipline of understanding information of an organization described using a language of the organization. An organization can compile one or more Business Glossaries, each representing a topic or a unit of the organization such as but not limited to, “Insurance,” “Internal Operations,” or “Human Resources.” Each Business Glossary namespaces Business Terms (e.g., “Policy,” “Policy Holder,” “Employee,” and so on) relevant to the topic corresponding to the Business Glossary (e.g., “Insurance”). Software Data Governance tools and software Data Cataloging tools are available for performing Data Governance functions for an organization based on Business Glossaries of Business Terms. Examples of such software tools include but are not limited to, Collibra®, Axon™ from Informatica®, IBM InfoSphere®, Alation®, Waterline®, and so on.

As used herein, Business Glossary refers to a collection of Business Terms representing the language used by all or part of an organization. The Business Glossary is a software asset used by organizations for Data Governance and can be implemented by a wide range of Data Governance tools. A Business Glossary is the de facto source of truth for information of an organization. Thus, requirements for new data assets are presented as a list of Business Terms.

A Business Term is a standard definition for a piece of information embodiment in an object, a class, or an element of a software tool. The Business Term includes the information and accompanying properties that define and/or classify that information. A Business Term has relationships with one or more other Business Terms of the Business Glossary as described herein. Business Glossaries can be mapped to show homonymous and synonymous vernaculars used internally in and externally to the organization. Such mapping enables information to be clearly defined with standards, owners, policies, and rules associated with the Business Terms.

A Logical Data Model is a model according to which data assets such as databases are documented, designed, or otherwise organized. A Logical Data Model contains Entities with Attributes, and relationships between the Entities. The names of objects within a Logical Data Model are typically expressed in business-friendly language as the Logical Data Model is used to communicate with users who are business stakeholders. An Entity is an object in a Logical Data Model that represents a concept. An Entity has Attributes and Relationships. An Attribute is an object part of an Entity that represents the properties or characteristics of the concept.

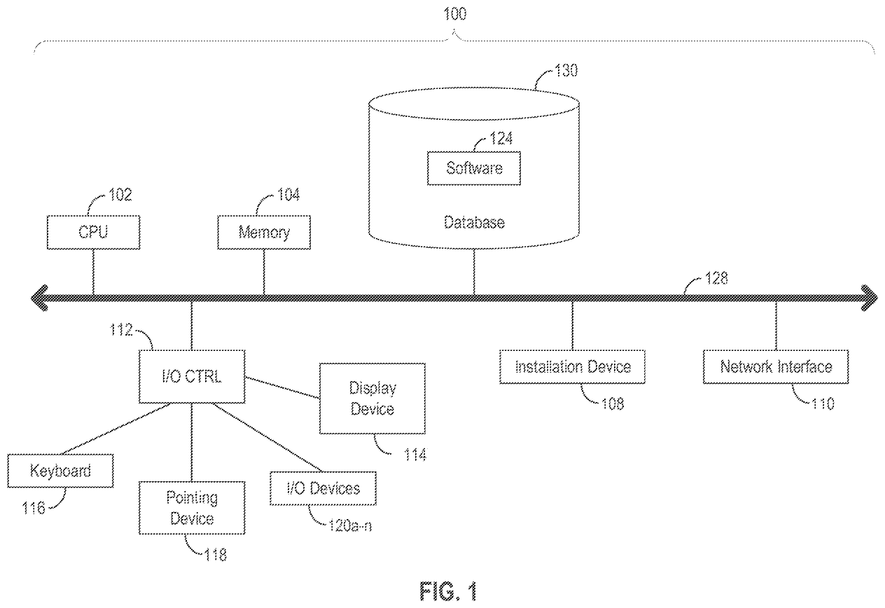

FIG. 1 is a block diagram depicting a computing system 100 capable of generating database assets, according to some arrangements. As shown in FIG. 1, in some examples, the computing system 100 includes a central processing unit (CPU) 102, a memory unit 104, a database 130, an installation device 108, a network interface 110, an input/output (I/O) controller 112, a display device 114, a keyboard 116, a pointing device 118 (e.g., a mouse), and so on. The database 130 can include, without limitation, software 124. The computing system 100 can also include additional elements such as but not limited to a memory port, a bridge, one or more input/output devices 120 (e.g., 120a-120n), cache memory in communication with the CPU 102, and so on.

In some examples, the CPU 102 can be any suitable logic circuitry that responds to and processes instructions fetched from the memory unit 104. In some examples, the CPU 102 is provided by a microprocessor unit. For example, in some examples, the microprocessor unit can include one or more microprocessors or any other suitable processor capable of operating as described herein. In various examples, the CPU 102 can utilize instruction level parallelism, thread level parallelism, different levels of cache, and/or multi-core processors. A multi-core processor can include two or more processing units on a single computing component.

In some examples, the memory unit 104 can include one or more memory chips capable of storing data and allowing any storage location to be directly accessed by the CPU 102. In various examples, the memory unit 104 can be Dynamic Random Access Memory (DRAM) or any variants, including Static Random Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), Extreme Data Rate DRAM (XDR DRAM), and so on. In some examples, the memory unit 104 and/or the database 130 can be non-volatile memory such as but not limited to, a Non-Volatile Read Access Memory (NVRAM), Flash Memory Non-Volatile Static RAM (nvSRAM), Ferroelectric RAM (FeRAM), Magnetoresistive RAM (MRAM), Phase-Change Memory (PRAM), Conductive-Bridging RAM (CBRAM), Silicon-Oxide-Nitride-Oxide-Silicon (SONOS), Resistive RAM (RRAM), Racetrack, Nano-RAM (NRAM), Millipede memory, and so on. The memory unit 104 can be based on any of the above-described memory devices, or any other available memory chips capable of operating as described herein. In some examples, the CPU 102 communicates with the memory unit 104 via a system bus 128. In other examples, the CPU 102 can communicate directly with the memory unit 104 via a memory port.

In some examples, the CPU 102 can communicate directly with cache memory via a secondary bus, sometimes referred to as a backside bus. In other examples, the CPU 102 can communicate with cache memory using the system bus 128. Cache memory typically has a faster response time than the memory unit 104, and is typically provided by SRAM, BSRAM, or EDRAM. In some examples, the CPU 102 communicates with various I/O devices 120 via a local system bus (e.g., the system bus 128). Various buses can be used to connect the CPU 102 to any of the I/O devices 120, including a PCI bus, a PCI-X bus, or a PCI-Express bus, or a NuBus. In examples in which the I/O devices 120 include the display device 114, the CPU 102 can use an Advanced Graphics Port (AGP) to communicate with the display device 114 or the I/O controller 112 for the display device 114.

In some examples, the CPU 102 can automatically convert and map a first data structure (e.g., a Business Glossary metamodel) to a second data structure (e.g., a Logical Data Model) in the manner described herein. In some examples, the CPU 102 can automatically create a third data structure (e.g., a Physical Data Model, such as but not limited to, a relational or dimensional physical model) using the second data structure. In some examples, the CPU 102 can automatically create database assets of the database 130 from the third data structure. In some examples, the database 130 (e.g., residing on one or more hard disk drives or redundant arrays of independent disks) can store related software (e.g., the software 124). The software 124 can be executed by the CPU 102 in order to generate the second data structure from the first data structure, to generate the third data structure from the second data structure, and to generate the data assets (e.g., the database 130). Thus, while the software 124 is shown to be implemented as part of the database 130, the software 124 can be executed by the CPU 102 and stored in the memory 104 to generate the database assets for the database 130.

In various examples, a wide variety of I/O devices 120a-120n can be included in the computing system 100. For example, in various examples, the input devices of the I/O devices 120a-120n can include but are not limited to keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, and/or other sensors. In various examples, the output devices of the I/O devices 120a-120n can include, for example, video displays, graphical displays, speakers, headphones, inkjet printers, laser printers, and/or 3D printers. In some examples, I/O devices 120a-120n can include a combination of multiple input or output devices.

In some examples, addition I/O devices 120a-120n can have both input and output capabilities, including, but not limited to for example, haptic feedback devices, touchscreen displays, multi-touch displays, and/or the like. Touchscreen, multi-touch displays, touchpads, touch mice, or other touch sensing devices can use different technologies to sense touch, including, for example, capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), force-based sensing technologies, and/or the like. Some multi-touch devices can allow two or more contact points with the surface, allowing advanced functionality including, for example, pinch, spread, rotate, scroll, and/or other gestures. In some examples, some of the I/O devices 120a-120n, display devices 114a-114n, or group of devices can be augment reality devices. In some examples, the I/O devices (e.g., keyboard 116, pointing device 118, display devices 114, and/or I/O devices 120) can be controlled by the I/O controller 112. In some examples, an I/O device can also provide storage and/or an installation medium (e.g., installation device 108) for the computing system 100. In still other examples, the computing system 100 can provide USB connections to receive handheld USB storage devices. In further examples, an I/O device 120 can be a bridge between the system bus 128 and an external communication bus, for example, such as a USB bus, a SCSI bus, a FireWire bus, an Ethernet bus, a Gigabit Ethernet bus, a Fibre Channel bus, a Thunderbolt bus, and/or the like.

In some examples, the display devices 114a-114n can be connected to the I/O controller 112. In various examples, the display devices 114a-114n can include any suitable electronic display device including, but not limited to, a liquid crystal display (LCD), a thin film transistor LCD (TFT-LCD), a blue phase LCD, an electronic papers (e-ink) display, a flexible display, a light emitting diode display (LED), a digital light processing (DLP) display, a liquid crystal on silicon (LCOS) display, an organic light-emitting diode (OLED) display, an active-matrix organic light-emitting diode (AMOLED) display, a liquid crystal laser display, a time-multiplexed optical shutter (TMOS) display, a 3D or stereoscopic display, and/or the like. Examples of 3D displays can include, for example, stereoscopy, polarization filters, active shutters, autostereoscopy, and/or the like. Display devices 114a-114n can also include a head-mounted display (HMD). In some examples, display devices 114a-114n or the corresponding I/O controllers 112 can be controlled through or have hardware support for OPENGL, DIRECTX API, and/or other graphics libraries.

Examples of hardware implementing the database 130 can include, but is not limited to, hard disk drive (HDD), optical drive including CD drive, solid-state drive (SSD), USB flash drive, and/or any other suitable device for storing data. In one example, the database 130 can be implemented using multiple volatile and non-volatile memories such as but not limited to, solid state hybrid drives that combine hard disks with solid state cache. In one example, the database 130 can be implemented on non-volatile, mutable, and/or read-only. In some examples, hardware implementing the database 130 is internal to the computing system 100 and can connect to other components of the computing system 100 via the bus 128. In some examples, one or more storage devices (not shown) implementing the database 130 are external to the computing system 100 and can be connect to the computing system 100 via an external bus of the I/O devices 120a-n. In some example, the database 130 connects to the computing system 100 via the network interface 110 over a network.

In some examples, the computing system 100 can include the network interface 110 to interface to a network through a variety of connections including, but not limited to, for example, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, and/or some combination of any or all of the above. Connections can be established using a variety of communication protocols (such as, but not limited to TCP/IP, Ethernet, ARCNET, SONET, SDH, Fiber Distributed Data Interface (FDDI), IEEE 802.11/b/g/n/ac CDMA, GSM, WiMax and direct asynchronous connections). In one example, the computing system 100 communicates with other computing devices via any type and/or form of gateway or tunneling protocol (e.g. Secure Socket Layer (SSL) or Transport Layer Security (TLS), or the Citrix Gateway Protocol manufactured by Citrix Systems, Inc. of Ft. Lauderdale, Fla.). In some examples, the network interface 110 can include, for example, a built-in network adapter, network interface card, PCMCIA network card, EXPRESSCARD network card, card bus network adapter, wireless network adapter, USB network adapter, modem, and/or any other suitable device for interfacing the computing system 100 to any type of network capable of communication and performing the operations described herein.

In various examples, the computing system 100 can be any workstation, desktop computer, laptop or notebook computer, tablet, server, handheld computer, mobile telephone, smartphone or other portable telecommunications device, media playing device, a gaming system, mobile computing device, and/or any other suitable type and/or form of computing, telecommunications, or media device that is capable of communication.

While some non-limiting examples of various computing devices of the system 100 and components thereof have been described herein, the present disclosure is not limited to. For example, other suitable computing devices and/or components thereof relating to one or more of the various aspects of the operating environments and components described above in the context of the systems and methods disclosed herein are contemplated, as will be apparent to those having ordinary skill in the art.

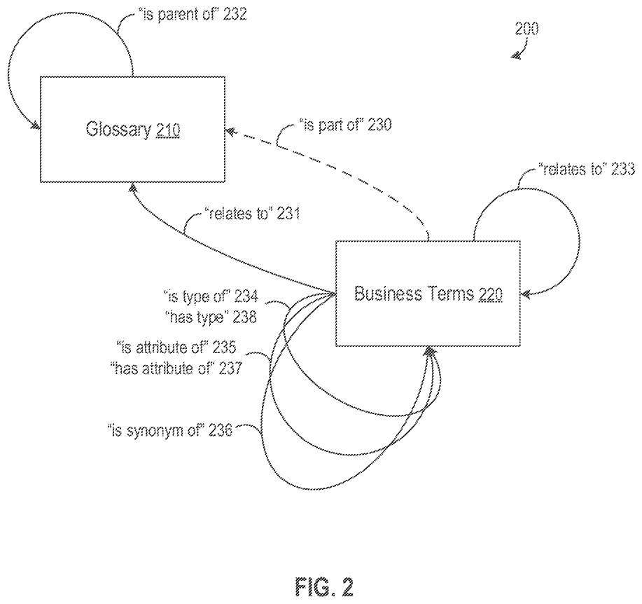

FIG. 2 is a diagram illustrating an example Business Glossary metamodel 200, according to some form of arrangements. Referring to FIGS. 1 and 2, the Business Glossary metamodel 200 includes a Glossary 210 (e.g., a Business Glossary) and Business Terms 220. The Business Terms 220 contain typed relationships among one another and thus forms a formal ontology. That is, the Glossary 210 is a collection of Business Terms 220 linked to one another via relationships that make up an ontology.

As shown, various types of relationships can exist among the Business Terms 220. For example, in a “relates to” relationship 233 of a first Business Term of the Business Terms 220, the first Business Term relates to a second Business Term of the Business Terms 220, vice versa. In the “relates to” relationship 233, term relationship or properties between the first Business Term and the second Business Term can be specified.

In an “is type of” relationship 234 of a first Business Term of the Business Terms 220, the first Business Term is a type of a second Business Term of the Business Terms 220. In other words, the first Business Term is an element within a set defined by the second Business Term. Similarly, in a “has type” relationship 238 of the first Business Term, a second Business Term of the Business Terms 220 is a type of the first Business Term. In other words, the second Business Term is an element within a set defined by the first Business Term.

In an “is attribute of” relationship 235 of a first Business Term of the Business Terms 220, the first Business Term is an attribute of a second Business Term of the Business Terms 220. In other words, the first Business Term is characteristic of the second Business Term. Similarly, in a “has attribute” relationship 237 of the first Business Term, a second Business Term of the Business Terms 220 is an attribute of the first Business Term. In other words, the second Business Term is characteristic of the first Business Term.

In an “is synonym of” relationship 236 of a first Business Term of the Business Terms 220, the first Business Term is a synonym of a second Business Term of the Business Terms 220, vice versa. In other words, the first Business Term and the second Business Term, though different Business Terms, are interchangeable.

The Business Terms 220 can also be related to the Glossary 210. For example, each of the Business Terms 220 is a part of the Glossary 210, in an “is part of” relationship 230. The each of the Business Terms 220 also relates to the Glossary 210, in a “relates to” relationship 231. Furthermore, the Glossary 210 is a parent of itself, in an “is parent of” relationship 232.

The “is part of” relationship 230 is an identifying relationship, while the rest of the relationships 231-238 are normal relationships. In this model 200, an identifying relationship shows that the child object is unique in the context of the parent object based on its name. For example, the Business Term “Policy” that is a part of the Glossary “Insurance” is unique and fundamentally different from the Business Term “policy” that is a part of the Business Glossary “Internal Operations.” Though the relationships 231-238 are shown in FIG. 2, other relationships among the Business Terms 220 and between the Business Terms 220 and the Glossary 210 can be likewise implemented in the Business Glossary metamodel 200.

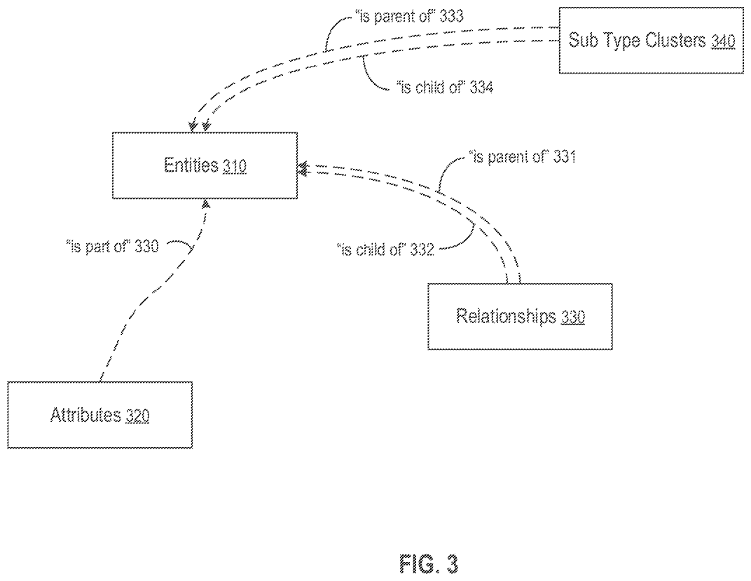

In constructing a database, data structures can be designed according to a Logical Data Model. FIG. 3 is a diagram illustrating an example Logical Data Model 300, according to some arrangements. As shown in FIG. 3, the Logical Data Model 300 includes Entities 310. Each of the Entities 310 has one or more Attributes 320. Thus, the Attributes 320 are a part of the Entities 310, in an “is part of” relationship 330.

Furthermore, the Entities 310 relate to one another via relationships 330. For example, in an “is parent of” relationship 331, a first Entity of the Entities 310 is a parent of a second Entity of the Entities 310. In another example, in an “is child of” relationship 332, a first Entity of the Entities 310 is a child of a second Entity of the Entities 310.

The Entities 310 can also relate to one another via SuperType and SubType, through SubType Clusters. A SubType Cluster refers to a group of Entities sharing similar characteristics that form a generalization hierarchy. In each SubType Cluster, there is one parent entity, known as a SuperType, and one or more SubType entities. The SuperType generalizes a set of SubTypes. The common characteristics or Attributes of SubType Entities are assigned to the SuperType, while the Subtype Entities have more specific attributes. The Subtypes, also known as Category Entities, represent homogeneous subsets of the SuperType. The Attributes and relationships (e.g., the Relationships 330) of the SuperType Entity are propagated to all of its Subtypes. Discriminators, an Attribute of the Subtype, distinguish the Entities in the Subtype from each other. In other words, in a SubType Cluster, Entities of different Subtypes share the same Attributes assigned to the SuperType while having different Attributes assigned to the different Subtypes. As shown, in an “is parent of” relationship 333, a first Entity of the Entities 310 is a SuperType (e.g., a parent) of a second Entity of the Entities 310, where the second Entity is a SubType generalized by the first Entity. In an “is child of” relationship 334, a first Entity of the Entities 310 is a SubType (e.g., a child) of a second Entity of the Entities 310, where the second Entity is a SuperType generalizing the first Entity.

Each of the relationships 330-334 is an identifying relationship. The Logical Data Model 300 does not have any normal relationships.

To generate the database 130 for use by stakeholders of an organization, codes deployable to the database 130 are generated. Objects and fields of the database 130 are mapped to the Business Terms 220 so that data can be found using the database 130 and rules applicable to the Business Terms 220 can be viewed with the interface of the database 130. Arrangements disclosed herein allow the software 124 to automatically convert knowledge within a first data structure (e.g., the Business Glossary metamodel 200) to a second data structure (e.g., the Logical Data Model 300). This ensures traceability between the design of the database 130 and the Data Governance initiative and reduces the time and risk of erroneous requirements gathering and approval phase by using existing knowledge of the organization and language more familiar with the stakeholders. The second data structure can be used to generate a third data structure (e.g., a Physical Data Model). The database 130 is generated using the third data structure.

As a Business Glossary is deemed to be the de-facto source of truth for the information of the organization, requirements for new data assets (e.g., a new database) may be presented as a list of Business Terms. The Business Glossary represents information expressed in language approved as used by the organization with clear definitions of the Business Terms and the structures by which of the Business Terms are organized. Given that conventionally, an operator is needed to manually enter correspondence between the Business Terms with one or more elements of the Logical Data Model after the Logical Data Model is created, arrangements disclosed herein relate to systems and methods that automate a manual process not previously automated before. Accordingly, arrangements disclosed herein can reduce human error and improve efficiency in creating data assets.

In some examples, given that the Business Terms 220 in the Business Glossary metamodel 200 contain typed relationships between the Business Terms 220 to form a formal ontology, the Business Glossary metamodel 200 can be used to generate the Logical Data Model 300. In that regard, generation of the Logical Data Model 300 also allows the Logical Data Model to be mapped back to the Business Terms 220, thus providing traceability.

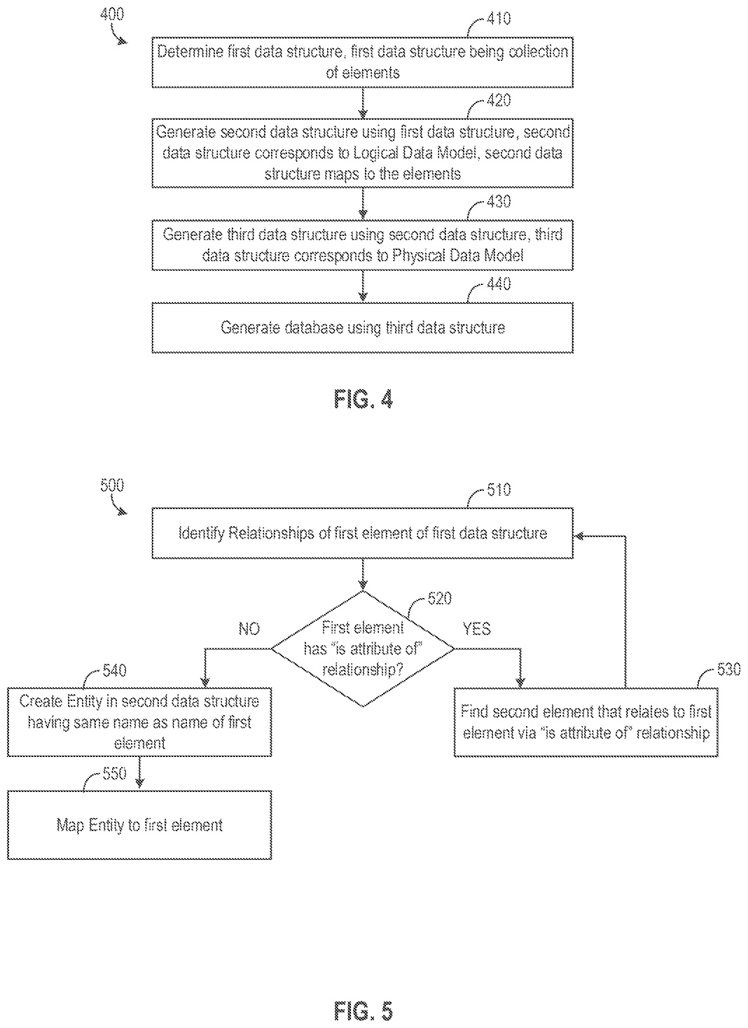

FIG. 4 is a flow diagram illustrating an example method 400 for generating a database, according to some arrangements. Referring to FIGS. 1-4, the method 400 can be performed by the software 124 and/or the CPU 102, referred to generally as the system 100.

At 410, the system 100 determines a first data structure, the first data structure is a collection of elements. Examples of the first data structure include the Business Glossary metamodel 200. As shown in FIG. 2, the Business Glossary metamodel 200 includes the Business Terms 220 and the Glossary 210, as well as relationships 230-238 among the Business Terms 220 and among the Business Terms 220 and the Glossary 210. Each of the elements is one of the Business Terms 220, thus the elements relate to one another. The Glossary 210, the Business Terms 220, and the relationships 230-238 correspond to established requirements for the content of the database 130.

The information related to the Business Glossary metamodel 200 (e.g., the Business Terms 220, the Glossary 210, and the relationships 230-238) can be obtained by an operator through an interview with stakeholders. In some examples, an operator inputs information related to the Business Glossary metamodel 200 using I/O devices of the system 100, including one or more of the keyboard 116, the pointing device 118, the I/O devices 120a-n, the display device 114, and the I/O control 112. The CPU 102 and/or the software 124 can translate the inputted information into a file. In some examples, the information related to the Business Glossary metamodel 200 can be received by the system 100 from another computing system via the network interface 110, and the CPU 102 and/or the software 124 can translate the received information into a file. In some examples, the file can be received by the system 100 from another computing system via the network interface 110.

At 420, the system 100 automatically generates a second data structure using the first data structure. The second data structure corresponds to the Logical Data Model 300. In other words, the system 100 can automatically generate the Logical Data Model 300 based on the Business Glossary metamodel 200, and in generating the Logical Data Model 300, the Business Terms 220 and the relationships 230-238 are mapped to the Logical Data Model 300. In one example, the second data structure (e.g., the Logical Data Model 300) is a logical data entity relation diagram expressed in a Third Normal Form (3NF).

In some arrangements, blocks 410 and 420 can be executed iteratively. That is, in response to any adjustments to the first data structure (e.g., the elements), the second data structure is also updated, modified, or regenerated according to the adjusted first data structure. The Logical Data Model 300 specifies any meaning, data types, nullability, classification, or usage rules specified in the Business Glossary metamodel 200.

The Logical Data Model 300 is developed before a Physical Data Model. The Logical Data Model 300 addresses the business and functional requirements of systems development. The Logical Data Model 300 allows determination of the organization or structure of the data to be stored in the database 130 before the database 130 is created. In other words, the Logical Data Model 300 serves as a mechanism for the Data Architect to communicate the requirements for the design of a database 130 to the business stakeholders in a business friendly format.

At 430, the system 100 generates a third data structure using the second data structure. The third data structure corresponds to a Physical Data Model which represents a technical blueprint or schema for the database 130. In other words, the software 124 translates the second data structure (e.g., the Logical Data Model 300) into the third data structure (e.g., a Physical Data Model). Examples of the Physical Data Model include but are not limited to, a relational model, a dimensional model, or so on.

In some arrangements, a target technology for the data asset (e.g., the database 130) has technology-specific rules by which the Logical Data Model 300 can be translated into the Physical Data Model. Examples of such technology-specific rules include rules relating to data type conversions, primary key constraints, foreign key constraints, naming conventions, and so on. For example, each of the Entities 310 is translated directly into a table of the Physical Data Model (e.g., a dimensional model). In a dimensional model, tables are automatically assigned types (e.g., fact, dimension, snowflake, undefined, and so on) based on an analysis of the schema. Each of the Attributes 320 translates directly into a table column. Each of the Relationships 330 is translated into a foreign key in the Physical Data Model. Referential integrity can be enforced through foreign key constraints. A primary key in the Logical Data Model 300 is translated into a unique index or a primary key constraint in the Physical Data Model. Primary keys with unique indexes or primary key constraints can be enforced in some database platforms. Data type conversion rules specify the manner by which a data type of the Logical Data Model 300 is converted into a data type of the Physical Data Model. For instance, a user data type in the Logical Data Model 300 can be translated into a user data type or a base data type in the Physical Data model.

In addition, the Physical Data model can be elaborated with physical-only artifacts such as but not limited to, Schemas, Users, Roles, ownership and rights thereof, Functions, Procedures, Views, and so on.

At 440, the system 100 generates the database 130 using the third data structure. For example, the system 100 can generate database code such as but not limited to, Dynamical Definition Language (DDL) code expressed as the Standard Query Language (SQL) for relational databases, or JSON relevant to a target NoSQL data asset product/platform (e.g., a platform on which the database 130 operates), and so on. The code can be applied to the data asset product/platform to create the data asset (e.g., the database 130).

FIG. 5 is a flow diagram illustrating an example method 500 for generating a second data structure using the first data structure, according to some arrangements. Referring to FIGS. 1-5, the method 500 can be performed by the software 124 and/or the CPU 102, referred to generally as the system 100. The method 500 is a particular implementation of block 420. In the method 500, the Entities 310 of the second data structure (e.g., the Logical Data Model 300) are identified and created from the Business Terms 220 of the first data structure (e.g., the Business Glossary metamodel 200).

At 510, the system 100 identifies relationships of a first element of the first data structure. The first element refers to a first Business Term of the Business Terms 220 of the Business Glossary metamodel 200. The relationships of the first Business Term can include one or more of the relationships 230-238.

At 520, the system 100 determines whether the first element has any “is attribute of” relationship 235 with at least one second element. The second element refers to a second Business Term of the Business Terms 220 of the Business Glossary metamodel 200. In other words, at 520, the system 100 determines whether the first element is an attribute of at least one second element. In response to determining that the first element has any “is attribute of” relationship 235 with at least one second element (520:YES), the system 100 finds (e.g., identifies) the at least one second element that relates to the first element via the “is attribute of” relationship 235 (e.g., the first element is an attribute of each of the at least one second element), at 530. For each of the at least one second element, the method 500 returns to 510, where each of the at least one second element is set to be the first element.

On the other hand, in response to determining that the first element does not have any “is attribute of” relationship 235 with any second element (520:NO), the system 100 creates a new Entity in the second data structure, at 540. That is, in response to determining that the first element is not an attribute of another element, a new Entity (e.g., a new Entity of the Entities 310 of the Logical Data Model 300) is created. The new Entity in the Logical Data Model 300 has the same name as the name of the first element of the Business Glossary metamodel 200. The newly created Entity of the Logical Data Model 300 is mapped to the first element of the Business Glossary metamodel 200. Blocks 540 and 550 are performed in response to 520:NO, in any suitable order.

The method 500 is performed for each element (e.g., each Business Term) of the first data structure. After all elements of the first data structure pass through the method 500, a separate second data structure is created. In other words, each Entity of the Logical Data Model 300 is created from a corresponding one of the Business Terms 220 and mapped to that corresponding Business Term as the Logical Data Model 300 is created.

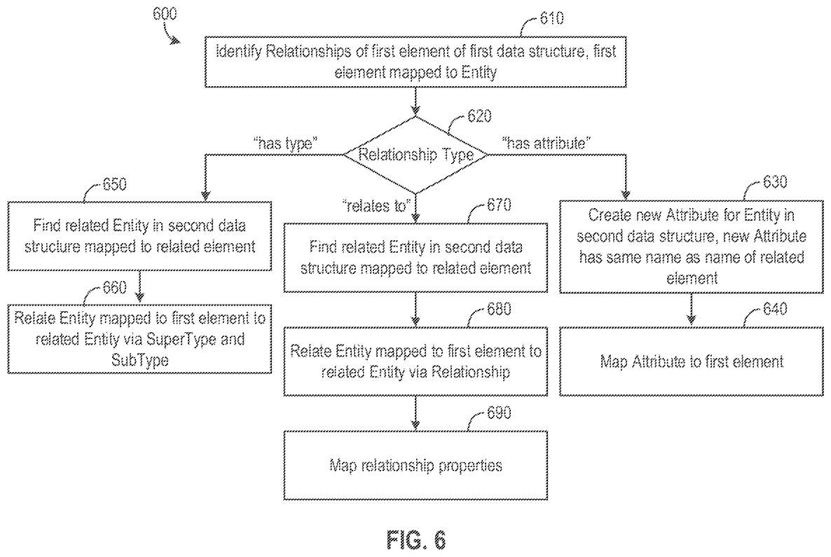

FIG. 6 is a flow diagram illustrating an example method 600 for generating a second data structure using the first data structure, according to some arrangements. Referring to FIGS. 1-6, the method 600 can be performed by the software 124 and/or the CPU 102, referred to generally as the system 100. The method 600 is a particular implementation of block 420, and is performed for each Entity of the second data structure created and mapped using the method 500. In the method 600, attributes and relationships of the Entities 310 of the second data structure (e.g., the Logical Data Model 300) are created from the first data structure (e.g., the Business Glossary metamodel 200).

At 610, the system 100 identifies relationships of the first element of the first data structure, where a new Entity of the second data structure is created (e.g., at 540) and mapped (e.g., at 550) based on the first element. The first element refers to a first Business Term of the Business Terms 220 of the Business Glossary metamodel 200. The Entity is one of the Entities 310 of the Logical Data Model 300. The relationships of the first Business Term can include one or more of the relationships 230-238.

At 620, the system 100 determines a relationship type of each of the relationships of the first element of the first data structure. In other words, the system 100 determines a relationship type for each relationship of the first Business Term. Thus, blocks 620-690 are performed for each relationship of the first Business Term.

In response to determining that the relationship type of a relationship of the first element of the first data structure is “has attribute” 237 (620: “has attribute”), the method 600 proceeds to block 630. As disclosed herein, the first element having a “has attribute” relationship 237 indicates that the first element has an attribute that is a related element (e.g., a related one of the Business Terms 220) of the first data structure. The related element is identified, and at 630, the system 100 creates a new Attribute for the Entity (created at 540 and mapped at 550) in the second data structure. The new Attribute is one of the Attributes 320 of the Logical Data Model 300. The new Attribute has the same name as the name of the related element. At 640, the system 100 maps the new Attribute to the related element.

In response to determining that the relationship type of a relationship of the first element of the first data structure is “has type” 238 (620: “has type”), the method 600 proceeds to block 650. As disclosed herein, the first element having a “has type” 238 relationship indicates that a related element (e.g., a related one of the Business Terms 220) of the first data structure is a type of the first element. The related element is identified, and at 650, the system 100 finds a related Entity in the second data structure that is mapped to the related element. The related Entity is one of the Entities 310 previously created and mapped using the method 500. Given that the related Entity and the related element have a same name, the system 100 can automatically search the Entities 310 by name to determine the related Entity.

At 660, the system 100 relates the newly created Entity (mapped to the first element) to the related Entity via SuperType and SubType. That is the Entity mapped to the first element and the related Entity form a SubType Cluster (one of the SubType Clusters 340). The Entity mapped to the first element is a SuperType in the SubType Cluster and has the “is parent of” relationship 333 with the related Entity. The related Entity is a SubType in the SubType Cluster and has the “is child of” relationship 334 with the Entity mapped to first element.

In response to determining that the relationship type of a relationship of the first element of the first data structure is “relates to” 233 (620: “relates to”), the method 600 proceeds to block 670. As disclosed herein, the first element having a “relates to” relationship 233 indicates the first element and a related element of the first data structure are related (with the properties of the relationship specified) in the first data structure. The related element is identified, and at 670, the system 100 finds a related Entity in the second data structure that is mapped to the related element. The related Entity is one of the Entities 310 previously created and mapped using the method 500. Given that the related Entity and the related element have a same name, the system 100 can automatically search the Entities 310 by name to determine the related Entity.

At 680, the system 100 relates the newly created Entity (mapped to the first element) to the related Entity via Relationship. That is, the relationship between the Entity mapped to the first element and the related Entity is added as one of the Relationships 330. A first one of the Entity mapped to the first element and the related Entity is a parent of a second one of the Entity mapped to the first element and the related Entity, in an “is parent of” relationship 331. The second one of the Entity mapped to the first element and the related Entity is a child of the first one of the Entity mapped to the first element and the related Entity, in an “is child of” relationship 332.

At 690, the system 100 maps relationship properties. For example, in response to determining the relationship between the first element (e.g., the first Business Term) and the related element (e.g., the related Business Term) has specified properties, the system 100 maps such properties to the Relationship of the second data structure created at 680. Examples of such properties include but are not limited to, Forward Phrase, Reverse Phrase, Cardinality, and so on.

Accordingly, the methods 500 and 600 identify Business Terms of the Business Glossary metamodel 200 to be translated into the Entities 310 of the Logical Data Model 300, Business Terms of the Business Glossary metamodel 200 to be translated into the Attributes 320 of the Logical Data Model 300, Business Terms of the Business Glossary metamodel 200 to be translated into the Relationships 330 of the Logical Data Model 300, and Business Terms of the Business Glossary metamodel 200 to be translated into the SubType Clusters 340 of the Logical Data Model 300. Such automated conversion automates a manual linking process that had not been previously automated, given that conventionally, the Business Glossary metamodel 200 and the Logical Data Model 300 are created separately, and linked manually after both are created.

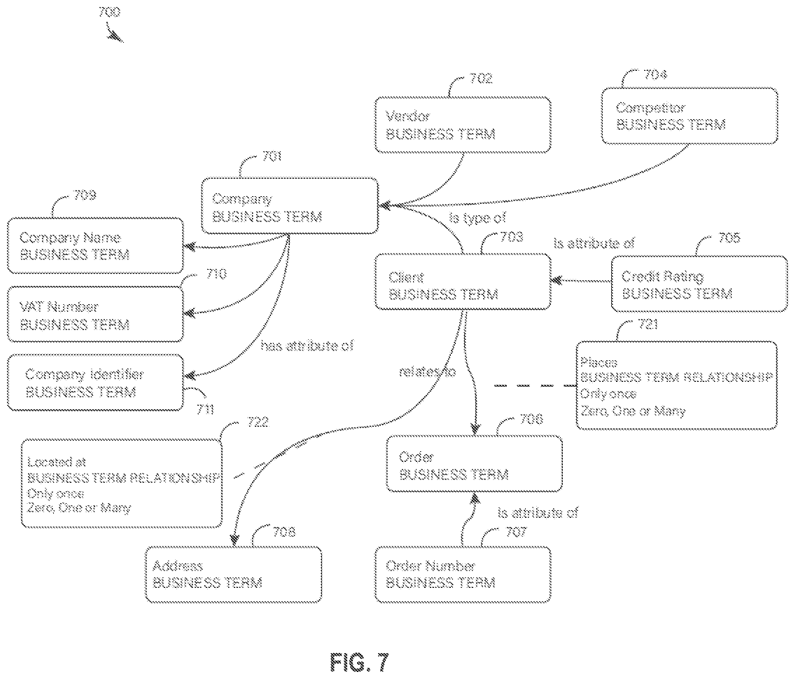

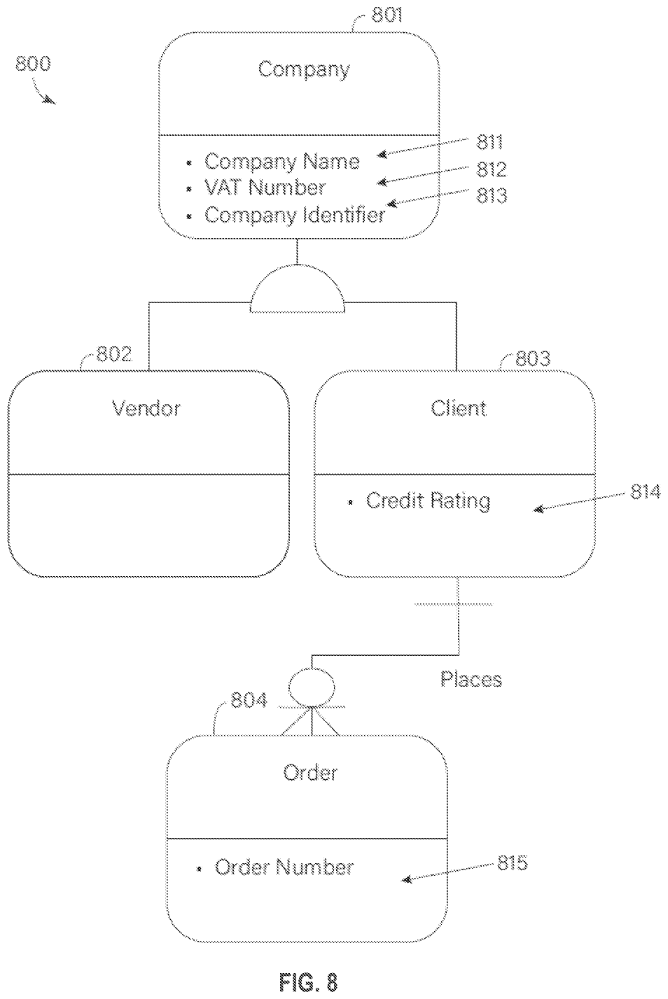

FIG. 7 is a diagram illustrating an example Business Glossary metamodel 700, according to some arrangements. FIG. 8 is a diagram illustrating an example Logical Data Model 800, according to some arrangements. Using the methods 500 and 600, the Logical Data Model 800 can be generated from the Business Glossary metamodel 700. The Business Glossary metamodel 700 is a particular example of the Business Glossary metamodel 200. The Logical Data Model 800 is a particular example of the Logical Data Model 300.

The Business Glossary metamodel 700 includes various elements or Business Terms (e.g., Business Terms 220), including Company 701, Vendor 702, Client 703, Competitor 704, Credit Rating 705, Order 706, Order Number 707, Address 708, Company Name 709, VAT Number 710, and Company identifier 711. Each of the Business Terms 701-711 is a piece of information the organization uses to describe their clients, suppliers and orders the company takes from clients. Company 701 has a “has attribute of” relationship 237 with Company Name 709, Vat Number 710, and Company Identifier 711. In other words, Company Name 709, Vat Number 710, and Company Identifier 711 are attributes of Company 701. The Vendor 702, Client 703, and Competitor 704 each has an “is type of” relationship 234 with Company 701. In other words, each of Vendor 702, Client 703, and Competitor 704 is a type of Company 701. Credit Rating 705 has an “is attribute of” relationship 235 with Client 703. In other words, Credit Rating 705 is an attribute of Client 703. Order Number 707 has an “is attribute of” relationship 235 with Order 706. In other words, Order Number 707 is an attribute of Order 706. Client 703 has a “relates to” relationship with each of Address 708 and Order 706. In other words, Client 703 relates to each of Address 708 and Order 706, vice versa. The properties or business term relationship 722 of the relationship between Client 703 and Address 708 include “located at,” which specifies that Address 708 corresponds to a location of Client 703. The properties or business term relationship of the relationship 721 between Client 703 and Order 706 include “places,” which specifies that Client 703 places Order 706.

In the method 500, the relationships of each of the Business Terms 701-711 in the Business Glossary metamodel 700 (first data structure) are identified at 510. Business Terms that are not attributes of other Business Terms are identified (520:NO), and Entities 801-804 corresponding to those Business Terms are created (e.g., at 540) and mapped (e.g., at 550). For example, the Logical Data Model 800 includes various Entities (e.g., Entities 310), including Company 801, Vendor 802, Client 803, and Order 804. Company 701 is mapped to Company 802, Vendor 702 is mapped to Vendor 802, Client 703 is mapped to Client 803, and Order 706 is mapped to Order 804.

In the method 600, the relationships of each of the Business Terms 701, 702, 703, and 706 are identified at 610, and the rest of the Logical Data Model 800 is generated based on the types of the relationships (e.g., at 620). For example, given that Company Name 709, Vat Number 710, and Company Identifier 711 are attributes of Company 701, new attributes 811, 812, and 813 of Company 801 are created in the Logical Data Model 800 at 630 and respectively mapped to Company Name 709, Vat Number 710, and Company Identifier 711 at 640. In another example, given that Credit Rating 705 is an attribute of Client 703, new attribute 814 of Client 803 is created the Logical Data Model 800 at 630 and mapped to Credit Rating 705 at 640. In another example, given that Order Number 707 is an attribute of Order 706, new attribute 815 of Order 706 is created the Logical Data Model 800 at 630 and mapped to Order Number 707 at 640.

In one example, given that each of Vendor 702 and Client 703 is a type of Company 701, Vendor 802 and Client 803 are related to Company 801 via SuperType and Subtype. For example, a SubType cluster is formed to include Company 801, Vendor 802, and Client 803, such that Company 801 is a SuperType, and Vendor 802 and Client 803 are SubTypes.

In one example, given that Order 706 relates to Client 703, Order 804 and Client 803 are related via Relationship at 680. At 690, the relationship properties, which include “places,” are mapped to the Relationship between Order 804 and Client 803.

The arrangements described herein have been described with reference to drawings. The drawings illustrate certain details of specific arrangements that implement the systems, methods and programs described herein. However, describing the arrangements with drawings should not be construed as imposing on the disclosure any limitations that can be present in the drawings.

It should be understood that no claim element herein is to be construed under the provisions of 35 U.S.C. § 112(f), unless the element is expressly recited using the phrase “means for.”

As used herein, the term “circuit” can include hardware structured to execute the functions described herein. In some arrangements, each respective “circuit” can include machine-readable media for configuring the hardware to execute the functions described herein. The circuit can be embodied as one or more circuitry components including, but not limited to, processing circuitry, network interfaces, peripheral devices, input devices, output devices, sensors, etc. In some arrangements, a circuit can take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” can include any type of component for accomplishing or facilitating achievement of the operations described herein. For example, a circuit as described herein can include one or more transistors, logic gates (e.g., NAND, AND, NOR, OR, XOR, NOT, XNOR, etc.), resistors, multiplexers, registers, capacitors, inductors, diodes, wiring, and so on).

The “circuit” can also include one or more processors communicatively coupled to one or more memory or memory devices. In this regard, the one or more processors can execute instructions stored in the memory or can execute instructions otherwise accessible to the one or more processors. In some arrangements, the one or more processors can be embodied in various ways. The one or more processors can be constructed in a manner sufficient to perform at least the operations described herein. In some arrangements, the one or more processors can be shared by multiple circuits (e.g., circuit A and circuit B can comprise or otherwise share the same processor which, in some example arrangements, can execute instructions stored, or otherwise accessed, via different areas of memory). Alternatively or additionally, the one or more processors can be structured to perform or otherwise execute certain operations independent of one or more co-processors. In other example arrangements, two or more processors can be coupled via a bus to enable independent, parallel, pipelined, or multi-threaded instruction execution. Each processor can be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors can take the form of a single core processor, multi-core processor (e.g., a dual core processor, triple core processor, quad core processor, etc.), microprocessor, etc. In some arrangements, the one or more processors can be external to the apparatus, for example the one or more processors can be a remote processor (e.g., a cloud based processor). Alternatively or additionally, the one or more processors can be internal and/or local to the apparatus. In this regard, a given circuit or components thereof can be disposed locally (e.g., as part of a local server, a local computing system, etc.) or remotely (e.g., as part of a remote server such as a cloud based server). To that end, a “circuit” as described herein can include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device can include non-transient volatile storage media, non-volatile storage media, non-transitory storage media (e.g., one or more volatile and/or non-volatile memories), etc. In some arrangements, the non-volatile media can take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media can take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device can be operable to maintain or otherwise store information relating to the operations performed by one or more associated circuits, including processor instructions and related data (e.g., database components, object code components, script components, etc.), in accordance with the example arrangements described herein.

It should be noted that although the diagrams herein can show a specific order and composition of method steps, it is understood that the order of these steps can differ from what is depicted. For example, two or more steps can be performed concurrently or with partial concurrence. Also, some method steps that are performed as discrete steps can be combined, steps being performed as a combined step can be separated into discrete steps, the sequence of certain processes can be reversed or otherwise varied, and the nature or number of discrete processes can be altered or varied. The order or sequence of any element or apparatus can be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

It is also understood that any reference to an element herein using a designation such as “first,” “second,” and so forth does not generally limit the quantity or order of those elements. Rather, these designations can be used herein as, a convenient means of distinguishing between two or more elements or instances of an element. Thus, a reference to first and second elements does not mean that only two elements can be employed, or that the first element must precede the second element in some manner.

The foregoing description of arrangements has been presented for purposes of illustration and description. It is not intended to be exhaustive or to limit the disclosure to the precise form disclosed, and modifications and variations are possible in light of the above teachings or can be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions can be made in the design, operating conditions and arrangement of the arrangements without departing from the scope of the present disclosure as expressed in the appended claims.

What is claimed is:

1. A method for generating a database using a first data structure comprising elements, comprising:
generating a second data structure using the first data structure, wherein the second data structure corresponds to a Logical Data Model, the second data structure mapped to the elements of the first data structure;
generating a third data structure using the second data structure, the third data structure corresponds to a Physical Data Model; and
generating the database using the third data structure.

2. The method of claim 1, wherein
the first data structure conforms to a Business Glossary metamodel; and
each of the elements comprises a Business Term.

3. The method of claim 1, wherein
the Physical Data Model is one of a relational model or a dimensional model; and
generating the database using the third data structure comprises generating a database code using the third data structure.

4. The method of claim 1, wherein the database code comprises Dynamical Definition Language (DDL) code expressed in Standard Query Language (SQL).

5. The method of claim 1, wherein the database code comprises JSON.

6. The method of claim 1, wherein the third data structure is generated using the second data structure based on one or more of data type conversions, primary key constraints, foreign key constraints, or naming conventions.

7. The method of claim 1, wherein generating the second data structure using the first data structure comprises:
identifying one or more relationships of each of the elements;
identifying one or more elements of the elements that do not have an “is attribute of” relationship with another element of the elements;
creating an Entity of the second data structure corresponding to each of the one or more elements; and
mapping the Entity to each of the one or more elements.

8. The method of claim 7, wherein generating the second data structure using the first data structure further comprises:
identifying one or more relationships of each of the one or more elements; and
creating one or more of Attributes, Relationships, or SubType cluster of the second data structure based on the one or more relationships.

9. A non-transitory computer-readable medium having computer-readable instructions such that, when executed by at least one processor, causes the processor to generate a database using a first data structure comprising elements by:
generating a second data structure using the first data structure, wherein the second data structure corresponds to a Logical Data Model, the second data structure mapped to the elements of the first data structure;
generating a third data structure using the second data structure, the third data structure corresponds to a Physical Data Model; and
generating the database using the third data structure.

10. The non-transitory computer-readable medium of claim 9, wherein
the first data structure corresponds to a Business Glossary metamodel; and
each of the elements comprises a Business Term.

11. The non-transitory computer-readable medium of claim 9, wherein
the Physical Data Model is one of a relational model or a dimensional model; and
generating the database using the third data structure comprises generating a database code using the third data structure.

12. The non-transitory computer-readable medium of claim 9, wherein the database code comprises Dynamical Definition Language (DDL) code expressed in Standard Query Language (SQL).

13. The non-transitory computer-readable medium of claim 9, wherein the database code comprises JSON.

14. The non-transitory computer-readable medium of claim 9, wherein the third data structure is generated using the second data structure based on one or more of data type conversions, primary key constraints, foreign key constraints, or naming conventions.

15. The non-transitory computer-readable medium of claim 9, wherein generating the second data structure using the first data structure comprises:
identifying one or more relationships of each of the elements;
identifying one or more elements of the elements that do not have an “is attribute of” relationship with another element of the elements;
creating an Entity of the second data structure corresponding to each of the one or more elements; and
mapping the Entity to each of the one or more elements.

16. The non-transitory computer-readable medium of claim 15, wherein generating the second data structure using the first data structure further comprises:
identifying one or more relationships of each of the one or more elements; and
creating one or more of Attributes, Relationships, or SubType cluster of the second data structure based on the one or more relationships.

17. A system for generating a database using a first data structure comprising elements, comprising:
a memory; and
a processor configured to:
generate a second data structure using the first data structure, wherein the second data structure corresponds to a Logical Data Model, the second data structure mapped to the elements of the first data structure;
generate a third data structure using the second data structure, the third data structure corresponds to a Physical Data Model; and
generate the database using the third data structure.

18. The system of claim 17, wherein
the first data structure conforms to a Business Glossary metamodel; and
each of the elements comprises a Business Term.

19. The system of claim 17, wherein generating the second data structure using the first data structure comprises:
identifying one or more relationships of each of the elements;
identifying one or more elements of the elements that do not have an “is attribute of” relationship with another element of the elements;
creating an Entity of the second data structure corresponding to each of the one or more elements; and
mapping the Entity to each of the one or more elements.

20. The system of claim 19, wherein generating the second data structure using the first data structure further comprises:
identifying one or more relationships of each of the one or more elements; and
creating one or more of Attributes, Relationships, or SubType cluster of the second data structure based on the one or more relationships.
